(19) United States
(12) Patent Application Publication
(10) Pub. No.: US 2020/0272601 A1
(43) Pub. Date: Aug. 27, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Kosuke KIKUSHIMA, Kanagawa (JP); Koji BITO, Kanagawa (JP); Naoto KASHIWAGI, Kanagawa (JP)

(73) Assignee: FUJI XEROX CO., LTD., Tokyo (JP)

(21) Appl. No.: 16/554,691

(22) Filed: Aug. 29, 2019

(30) Foreign Application Priority Data
Feb. 27, 2019 (JP) 2019-034225

(51) Int. Cl. G06F 16/14; G06F 21/62; G06F 16/16

(52) U.S. Cl. CPC G06F 16/148; G06F 16/168; G06F 21/6218; G06F 21/6209

(57) ABSTRACT

An information processing apparatus includes: a search part that searches for data that includes information used for searching: a setting part that, in a case where it is not possible to access the information, sets the data that includes the information that cannot be accessed, to be excluded from a search performed by the search part; and a display controller that causes a display part to display the result of the search performed by the search part, and causes the display part to display the data that has been set to be excluded from the search by the setting part.

### CROSS-REFERENCE TO RELATED APPLICATIONS

This application is based on and claims priority under 35 USC 119 from Japanese Patent Application No. 2019-034225 filed Feb. 27, 2019.

### BACKGROUND

### (i) Technical Field

The present disclosure relates to an information processing apparatus and a non-transitory computer readable medium.

### (ii) Related Art

When information that is used for searching for data is included in the data, there are cases where a search is performed for the data using the information.

Japanese Unexamined Patent Application Publication No. 2006-259942 describes a system in which, if a client terminal is connected to a server, access to a file is permitted, and if the client terminal is not connected to the server, the attributes of the file are not displayed on a screen and the file is excluded from a search.

### SUMMARY

In this regard, due to data being encrypted or the like, there are cases where it is not possible to access information used to search for the data and it is not possible to use the information to search for the data. In such cases, it is not possible to search for the data using the information, and the data is not output as a search result. As a result, the user is not able to perceive which data includes inaccessible information.

Aspects of non-limiting embodiments of the present disclosure relate to making it possible for a user to perceive which data includes inaccessible information even in a case where it is not possible to access information used for searching for data.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including: a search part that searches for data that includes information used for searching: a setting part that, in a case where it is not possible to access the information, sets the data that includes the information that cannot be accessed, to be excluded from a search performed by the search part; and a display controller that causes a display part to display the result of the search performed by the search part, and causes the display part to display the data that has been set to be excluded from the search by the setting part.

### BRIEF DESCRIPTION OF THE DRAWINGS

An exemplary embodiment of the present disclosure will be described in detail based on the following figures, wherein:

FIG. 1 is a block diagram depicting the configuration of an information processing apparatus according to the present exemplary embodiment;

FIG. 2 is a drawing depicting the structure of data;

FIG. 3 is a drawing depicting a screen displaying a list of data;

FIG. 4 is a drawing depicting a screen;

FIG. 5 is a drawing depicting a screen;

FIG. 6 is a drawing depicting a screen;

FIG. 7 is a drawing depicting a screen;

FIG. 8 is a drawing depicting a screen;

FIG. 9 is a drawing depicting a screen;

FIG. 10 is a drawing depicting a screen;

FIG. 11 is a drawing depicting a screen; and

FIG. 12 is a drawing depicting a screen.

### DETAILED DESCRIPTION

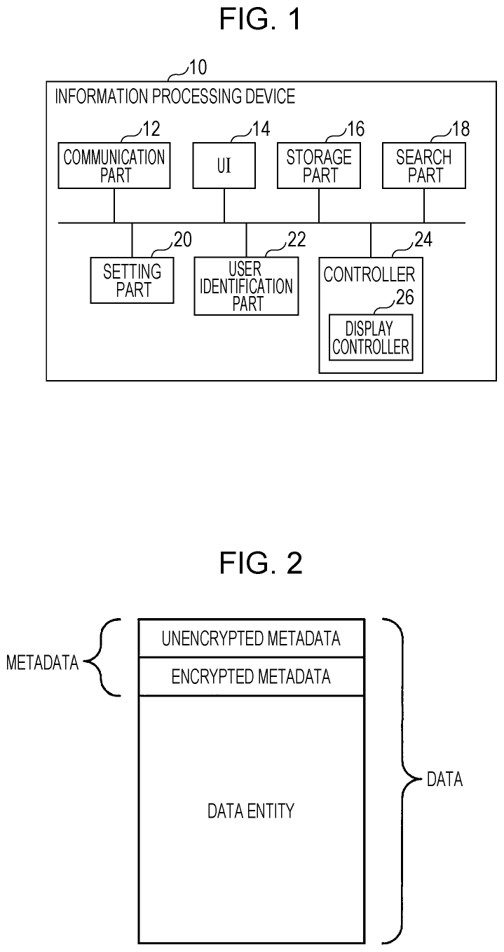

An information processing apparatus according to an exemplary embodiment of the present disclosure will be described hereinafter. FIG. 1 depicts the configuration of an information processing apparatus 10 according to the present exemplary embodiment.

The information processing apparatus 10 is an apparatus that is configured to search for data and display the result of the search. The search result may be displayed on the information processing apparatus 10, may not be displayed on the information processing apparatus 10, or may be displayed on the information processing apparatus 10 and also displayed on another apparatus. The information processing apparatus 10 is, for example, a terminal apparatus such as a personal computer (referred to as a “PC” hereinafter), a tablet PC, a smartphone, or a cellular telephone. The information processing apparatus 10, which is a terminal apparatus, searches for data and displays the result of the search on the information processing apparatus 10 itself. As another example, the information processing apparatus 10 may be a server that is configured to search for data. The information processing apparatus 10, which is a server, receives a search instruction from a terminal apparatus such as a PC via a communication path, searches for data in accordance with the search instruction, and transmits a search result to the terminal apparatus via the communication path. The search result is displayed on the terminal apparatus. The communication path is a network such as the Internet or a LAN (local area network), for example. In this way, the information processing apparatus 10 may cause the search result to be displayed on the information processing apparatus 10 itself or to be displayed on another apparatus. Hereinafter, as an example, it is assumed that the information processing apparatus 10 is a terminal apparatus.

A communication part 12 is a communication interface and has a function of transmitting information to other apparatuses and a function of receiving information transmitted from other apparatuses. The communication part 12 may have a wireless communication function or may have a wired communication function.

A UI 14 is a user interface and includes a display part and an operation part. The display part is a display apparatus such as a liquid crystal display or an EL display, for example. The operation part is constituted by input apparatuses such as a keyboard and a mouse. A user interface provided with both a display part and an operation part (for example, a touch panel or the like) may be used as the UI 14.

A storage part 16 is constituted by one or more storage areas where various information is stored. The storage areas may be defined as one or more storage apparatuses (for example, physical drives such as hard disk drives or memories) provided in the information processing apparatus 10, or may be defined as logical partitions or logical drives that are set in one or more storage apparatuses.

A search part 18 is configured to search for data in accordance with a search instruction. The data includes information that is used for searching. In a case where a search using the information is instructed, the search part 18 searches for data on the basis of the information. The information used for searching will be described in detail later with reference to FIG. 2.

The search instruction is provided by a user, for example. The search part 18 may search for one or more items of data stored in the storage part 16, or may search for one or more items of data stored in an external apparatus other than the information processing apparatus 10 (for example, a database, a web server, a file server, the cloud, and the like). Data to be searched is, for example, document data, image data (for example, still image data or video image data), speech data, and the like. It goes without saying that a search may be performed for data other than the aforementioned. A search may be performed for a web page.

The search part 18 searches for data using a search query that has been input by the user, for example. The search query is a character, a character string, an image, or the like that has been input by the user for searching. As a character or a character string, for example, a word, a phrase, a compound word, or the like is used. Furthermore, the search part 18 may search for data in accordance with a search condition that has been designated by the user (a search expression or the like such as an AND search or an OR search, for example). The search part 18 is not limited to the aforementioned and may search for data using a publicly known technique related to searching.

In a case where it is not possible to access information used for searching, a setting part 20 is configured to set data that includes the inaccessible information to be excluded from a search performed by the search part 18. The search part 18 does not search for data that has been set to be excluded from a search. More specifically, the setting part 20 sets data that includes the inaccessible information to be excluded from a search that uses the inaccessible information. In this case, a search is not performed for the data that has been set to be excluded from a search, by the search part 18 using the inaccessible information. The case where a user who has instructed a search does not have permission to access the information in question (namely the access right), the case where the search part 18 is not able to access the information to read the information and is not able to use the information to search for data, and the like are included within the concept of a case where it is not possible to access information used for a search. For example, if the user does not have an access right for information, the search part 18 is not able to access the information.

Data that includes inaccessible information is, for example, encrypted data. For instance, when some or all of the information used for a search is encrypted, it is not possible to access the information that has been encrypted. More specifically, data that includes inaccessible information is data that has been encrypted and is not permitted to be decrypted by the user who has instructed a search (that is, data for which the user does not have a decryption right). A decryption right means a permission for accessing encrypted data, and corresponds to an example of the aforementioned access right. For example, a user who is not provided with information for decryption (for example, a password, an electronic certificate, or the like), a user who is provided with information for decryption but is temporarily not permitted to use the information for decryption, and the like are included within the concept of a user who is not permitted to decrypt data. The type of encryption is not particularly limited.

It should be noted that encrypted data is merely one example of data that includes inaccessible information, and data other than encrypted data may be an example of data that includes inaccessible information.

A user identification part 22 is configured to identify a user. For example, the user identification part 22 may identify a user who uses the information processing apparatus 10, or may identify a user who instructs a search. For example, the user identification part 22 identifies a user who logs in to the information processing apparatus 10. A publicly known technique is used for identification processing for the user. For example, a user ID, a password, face authentication, voice authentication, fingerprint authentication, or the like is used for the identification processing. In the present exemplary embodiment, the user identification part 22 executes identification processing to thereby determine whether or not the user corresponds to a user who has the aforementioned access right. Specifically, the user identification part 22 determines whether or not the user corresponds to a user who has the aforementioned decryption right. For example, user identification information for identifying a user who has the decryption right, which is an example of an access right, is stored in the storage part 16 or an external apparatus. The user identification information corresponds to information that is used in the aforementioned authentication processing, and, for example, includes a user ID, a password, an image representing the face of the user, speech representing the voice of the user, an image representing a fingerprint of the user, or the like. For example, the user identification information (for example, a user ID, a password, a facial image, speech, a fingerprint image, or the like) is input via the UI 14 when the information processing apparatus 10 is used or a search is performed. In a case where the user identification information that has been input is stored in the storage part 16 or an external apparatus as user identification information for a user who has the decryption right, the user identification part 22 determines that the user corresponds to a user who has the decryption right. In a case where the user identification information that has been input is not stored in the storage part 16 or an external apparatus as user identification information for a user who has the decryption right, the user identification part 22 determines that the user does not correspond to a user who has the decryption right.

In a case where the user does not have the decryption right, the setting part 20 sets the encrypted data to be excluded from a search that uses the inaccessible information. In a case where the user has the decryption right, the setting part 20 does not set the encrypted data to be excluded from a search performed by the search part 18.

A controller 24 is configured to control the operation of each part of the information processing apparatus 10. Furthermore, the controller 24 includes a display controller 26.

The display controller 26 is configured to cause a display part of the UI 14 to display various information (for example, images, character strings, or the like). The display controller 26, for example, causes the display part to display the result of a search performed by the search part 18, and causes the display part to display data that has been set to be excluded from the search by the setting part 20.

An example of the structure of data will be described with reference to FIG. 2 hereinafter.

The data is, for example, image data, document data, speech data, or the like, and includes a data entity and metadata. A data entity within image data is an image itself (for example, bitmap image data or the like), a data entity within document data is a document itself (for example, text data or the like), and a data entity within speech data is speech itself. Metadata is an example of information that is used to search for data. Metadata is attribute information that is added to a data entity and indicates data attributes. Data attributes are, for example, the name of the data, a generation date/time of the data, an update date/time of the data, the size of the data (namely the data volume), the type of data, other features of the data, and the like. Metadata includes these items of information. The type of data is determined by the data format, for example. Image data, document data, speech data, and the like are included within the concept of a type of data. Other features, for example, may be determined by the user, or may be automatically extracted from the data entity by means of artificial intelligence (AI) or the like. For example, keywords or the like indicating other features are included in the metadata. The other features may be the relevant classification or the like when data is classified based on the content of the data entity. For example, in a case where document data is data relating to a person, information indicating the person may be included in the metadata as information indicating other features. Furthermore, in a case where document data is data relating to a technical field, information indicating the technical field may be included in the metadata as information indicating other features. It goes without saying that information indicating features other than these may be included in the metadata.

In a case where data is subjected to encryption processing, there are occasions where some or all of the metadata is encrypted as well as the data entity being encrypted. It goes without saying that there are also occasions where the metadata is not encrypted even though data is subjected to encryption processing. For example, some or all of the metadata may be encrypted or the metadata may not be encrypted in accordance with settings implemented during the encryption processing, system settings used in the encryption processing, user settings, and the like. Here, as an example, it is assumed that some of the metadata has been encrypted due to encryption processing. In this case, the metadata is composed of metadata that has been encrypted and metadata that has not been encrypted. Hereinafter, metadata that has been encrypted will be referred to as “encrypted metadata” and metadata that has not been encrypted will be referred to as “unencrypted metadata”.

For example, within the metadata, information indicating the name of the data, information indicating the generation date/time of the data, information indicating an update date/time of the data, and information indicating the size of the data is not encrypted, and these items of information are included in the unencrypted metadata. Within the metadata, information indicating other features is encrypted and included in the encrypted metadata. For example, information indicating the classification of the data is encrypted and included in the encrypted metadata. It goes without saying that these are merely examples. Information indicating the name of the data or the like may be encrypted and included in the encrypted metadata, and some or all information indicating other features may not be encrypted and included in the unencrypted data. The encryption or non-encryption of metadata may be set by the user, may be set in advance, or may be automatically set according to the data type or the like.

Unencrypted metadata corresponds to an example of information that is used for searching and is accessible information. Encrypted metadata corresponds to an example of information that is used for searching and is inaccessible information. Consequently, the setting part 20 sets encrypted data that includes encrypted metadata to be excluded from a search that uses the encrypted metadata.

The setting part 20 may set all encrypted data that includes encrypted metadata to be excluded from a search performed by the search part 18, or may set encrypted data for which the user who is performing the search does not have a decryption right to be excluded from a search performed by the search part 18.

For example, for a user who does not have a decryption right for decrypting encrypted data, encrypted metadata that is included in encrypted data corresponds to inaccessible information. Consequently, in a case where a user who does not have a decryption right performs a search, the setting part 20 sets the encrypted data to be excluded from a search that uses the encrypted metadata.

Meanwhile, for a user who has a decryption right for decrypting encrypted data, encrypted metadata that is included in encrypted data corresponds to accessible information. Consequently, in a case where a user who has a decryption right performs a search, the setting part 20 does not set the encrypted data to be excluded from a search performed by the search part 18.

Processing performed by the information processing apparatus 10 will be described in detail with specific examples hereinafter.

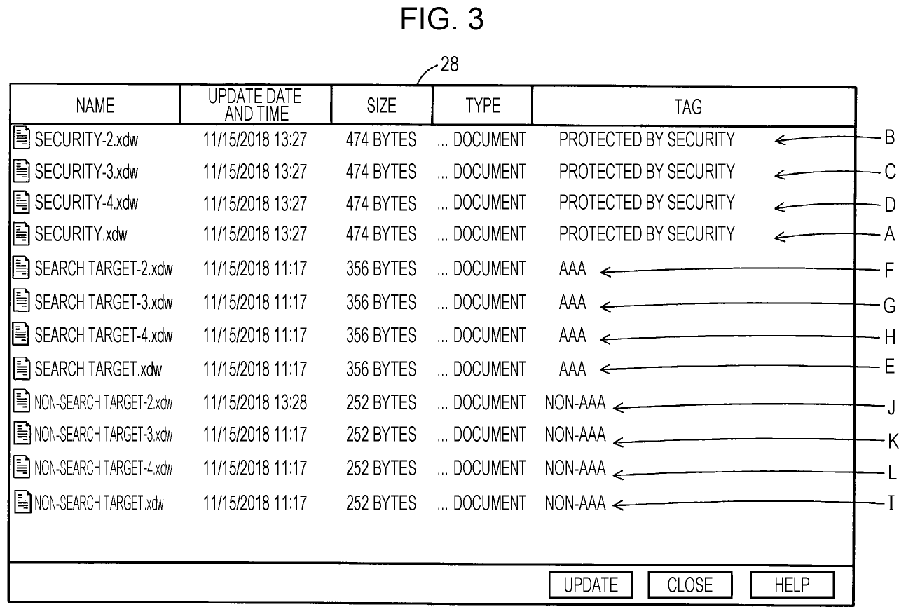

FIG. 3 depicts an example of a screen that displays a list of data. The screen 28 displays a list of data to be searched. For example, if the user designates a storage area in which data is stored (for example, a folder or the like) by operating the UI 14, the display controller 26 causes the display part of the UI 14 to display the screen 28 which displays a list of data stored in the storage area. The storage area may be a storage area formed in the storage part 16, or may be a storage area formed in an external apparatus outside of the information processing apparatus 10.

The screen 28 displays some or all of the metadata included in each item of data. For example, information indicating the name of the data, information indicating an update date/time of the data, information indicating the size of the data, information indicating the type of data, and tag information are displayed as metadata. The tag information corresponds to an example of information indicating other features mentioned above. As an example, each item of data displayed in the screen 28 is document data.

The user identification part 22, for example, determines whether or not the user has a decryption right for data on the basis of user identification information (for example, a user ID, a password, or the like) that has been input by the user when logging in to the information processing apparatus 10. Here, as an example, it is assumed that a user α who does not have a decryption right for data has logged in to the information processing apparatus 10.

Within the data group displayed on the screen 28, data A, B, C, and D is encrypted data for which the user α does not have a decryption right. Here, the data entity (for example, the portion representing a document) of each item of data A, B, C, and D is encrypted, and the respective metadata portions are also encrypted. Specifically, the tag information is encrypted, and the encrypted tag information corresponds to an example of encrypted metadata. Information indicating the name of the data, information indicating an update date/time of the data, information indicating the size of the data, and information indicating the type of data are not encrypted, and these items of information correspond to examples of unencrypted metadata. Since the tag information is encrypted, a character string such as “protected by security” is displayed in a display field for tag information in association with each item of data A, B, C, and D.

Data E, F, G, and H is data that is not encrypted. Data E, F, G, and H is data relating to a specific person “AAA”, and tag information indicating the specific person “AAA” is included in the metadata of each item of data E, F, G, and H. Furthermore, a character string “AAA” indicating the specific person is displayed in the display field for tag information in association with each item of data E, F, G, and H.

Data I, J, K, and L is data that is not encrypted. Data I, J, K, and L is data that is unrelated to the specific person “AAA”, and tag information indicating being unrelated to the specific person “AAA” is included in the metadata of each item of data I, J, K, and L. Furthermore, a character string “non-AAA” indicating that the data is unrelated to the specific person is displayed in the display field for tag information in association with each item of data I, J, K, and L.

Since the tag information of each item of data A, B, C, and D is encrypted, the setting part 20 sets the encrypted data A, B, C, and D to be excluded from a search that uses tag information that is encrypted metadata. Thus, in a case where tag information that is encrypted metadata is used as a search query, the search part 18 searches for data corresponding to the search query from among data E to L that is not encrypted. Meanwhile, in a case where unencrypted metadata such as the name, update date/time, size, or type of data is used as a search query, the search part 18 searches for data corresponding to the search query from among data A to D that is encrypted and data E to L that is not encrypted.

It should be noted that, in a case where a user who has a decryption right for the data has logged in to the information processing apparatus 10, the tag information included in the metadata of each item of data A, B, C, and D is also displayed on the screen 28. Furthermore, data A, B, C, and D is not set to be excluded from a search. Consequently, in a case where tag information is used as a search query, the search part 18 searches for data corresponding to the search query from among data A to L.

If the user provides a search instruction by operating the UI 14 and designating a search query and a search condition, the search part 18 searches for data in accordance with the search query and the search condition. For example, the display controller 26 causes the display part of the UI 14 to display a screen for inputting a search query and a search condition. The user provides a search instruction by inputting a search query and a search condition on the screen.

Here, as an example, it is assumed that the user α who does not have a decryption right has designated the character string “AAA”, which is tag information, as a search query and instructed the execution of a search that uses the tag information. Since the execution of a search which uses tag information that is encrypted metadata has been instructed, the search part 18 searches for data having metadata that includes tag information indicating the character string “AAA” from among data E to L that is not encrypted. The metadata included in each item of data E, F, G, and H includes tag information indicating the character string “AAA”, and therefore data E, F, G, and H is retrieved.

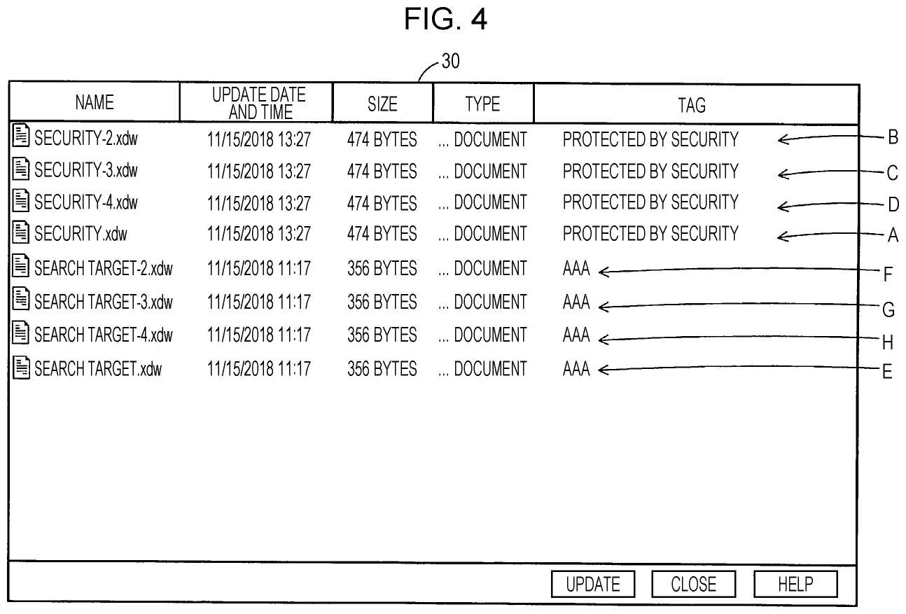

FIG. 4 depicts an example of a screen that displays a search result. The screen 30 displays the result of a search performed by the search part 18, and data that has been set to be excluded from the search by the setting part 20. Data E, F, G, and H has been retrieved by the search part 18 and data A, B, C, and D has been set to be excluded from the search, and therefore the display controller 26 causes the display part of the UI 14 to display the screen 30 displaying data E, F, G, and H that is the search result and data A, B, C, and D that has been set to be excluded from the search. For example, data A, B, C, and D and data E, F, G, and H are displayed on the same screen 30. In this way, data A, B, C, and D which is encrypted data and has been set to be excluded from a search which uses tag information that is encrypted metadata is also displayed together with the result of the search performed by the search part 18.

Hereinafter, a mode in which data that is the result of a search performed by the search part 18 and data that has been set to be excluded from a search by the setting part 20 are displayed on the same screen will be referred to as a “first mode”.

As described above, data that has been set to be excluded from a search is displayed, and therefore the user is able to perceive which data includes inaccessible information, even in a case where it is not possible to access information (for example, metadata) used for searching for data. For example, the user is able to perceive which data has been encrypted and cannot be decrypted by the user himself or herself.

It should be noted that, in a case where the user has designated unencrypted data as a search query and instructed the execution of a search that uses unencrypted data, the search part 18 searches for data from among data A to D that is encrypted and data E to L that is not encrypted. For example, in a case where the user has designated the name of data (for example, the character string “security”) as a search query and instructed the execution of a search that uses the name of the data, since the execution of a search which uses a name that is unencrypted data has been instructed, the search part 18 searches for data having metadata that includes name information indicating the character string “security” from among data A to D that is encrypted and data E to L that is not encrypted. The metadata included in each item of data A, B, C, and D includes name information indicating the character string “security”, and therefore data A, B, C, and D is retrieved. Data A, B, C, and D is displayed on the display part of the UI 14 as a search result.

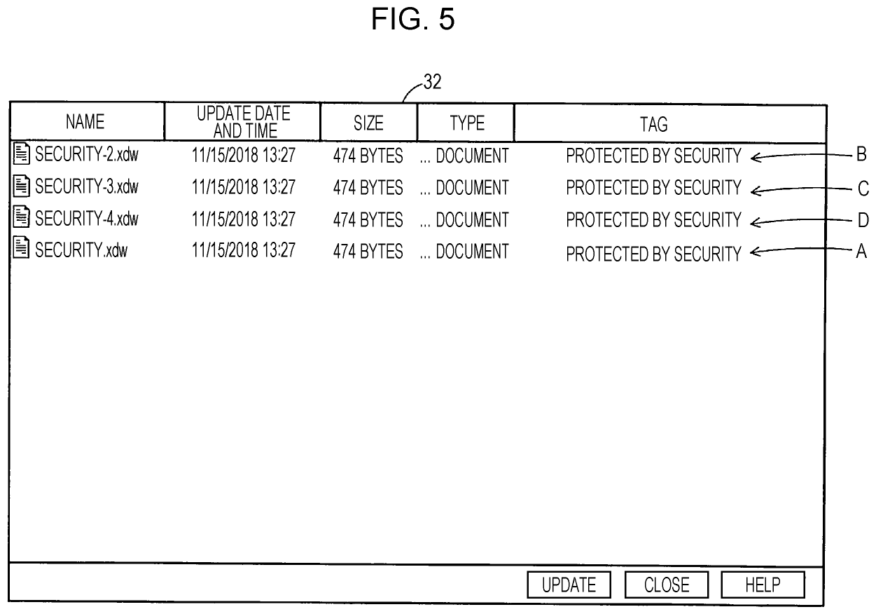

The display controller 26 may cause the display part of the UI 14 to display only data that has been set to be excluded from a search by the setting part 20. FIG. 5 depicts a display example thereof. A screen 32 displays only data A, B, C, and D that has been set to be excluded from a search. For example, in a case where a search is executed by the search part 18, the display controller 26 does not cause data E, F, G, and H that is the result of the search performed by the search part 18 to be displayed on the screen 32, and causes only data A, B, C, and D to be displayed on the screen 32.

Hereinafter, a mode in which data that is the result of a search performed by the search part 18 is not displayed on the display part and data that has been set to be excluded from the search by the setting part 20 is displayed on the display part will be referred to as a “second mode”.

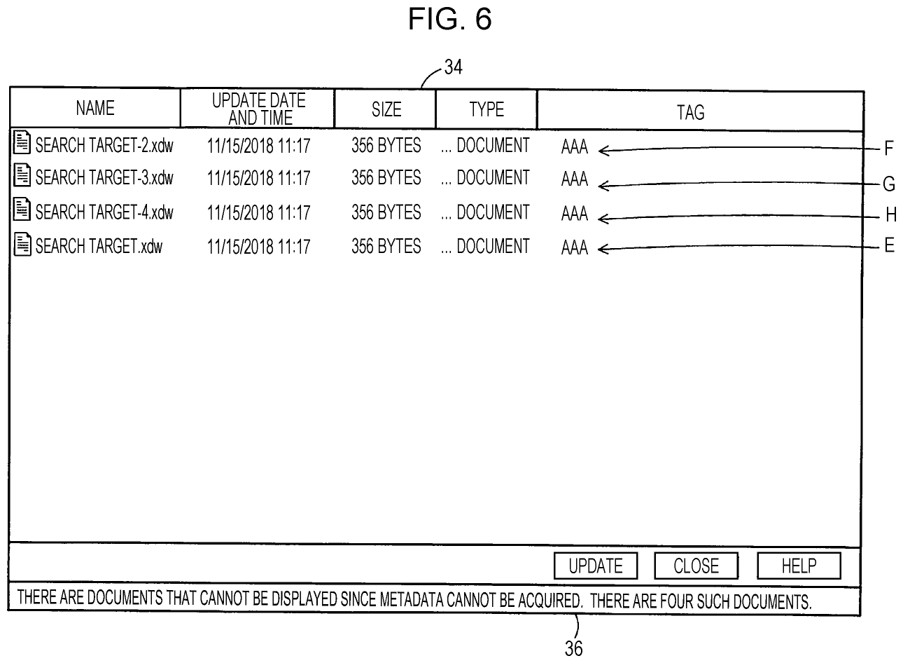

The display controller 26 may cause the display part of the UI 14 to display only the result of a search performed by the search part 18. FIG. 6 depicts a display example thereof. A screen 34 displays only data E, F, G, and H that is the result of a search performed by the search part 18. For example, in a case where a search is executed by the search part 18, the display controller 26 causes data E, F, G, and H that is the result of the search performed by the search part 18 to be displayed on the screen 34, and does not cause other data to be displayed on the screen 34. In this case, the display controller 26 may cause the screen 34 to display information indicating that there is data that has been set to be excluded from the search by the setting part 20, and information indicating the quantity of such data. Data A, B, C, and D has been set to be excluded from the search, and therefore the quantity of data that has been set to be excluded from the search is four. Consequently, information indicating that quantity is displayed on the screen 34 as indicated by reference number 36.

Hereinafter, a mode in which data that has been set to be excluded from a search by the setting part 20 is not displayed on the display part, and data that is the result of a search performed by the search part 18 is displayed on the display part will be referred to as a “third mode”.

It should be noted that the display controller 26 may cause the display part to display both data A, B, C, and D that has been set to be excluded from a search by the setting part 20 and information indicating the quantity of such data (for example, four). For example, the display controller 26 may cause information indicating the number (for example, four) to be displayed on the screen 30 depicted in FIG. 4, or may cause information indicating the number to be displayed on the screen 32 depicted in FIG. 5.

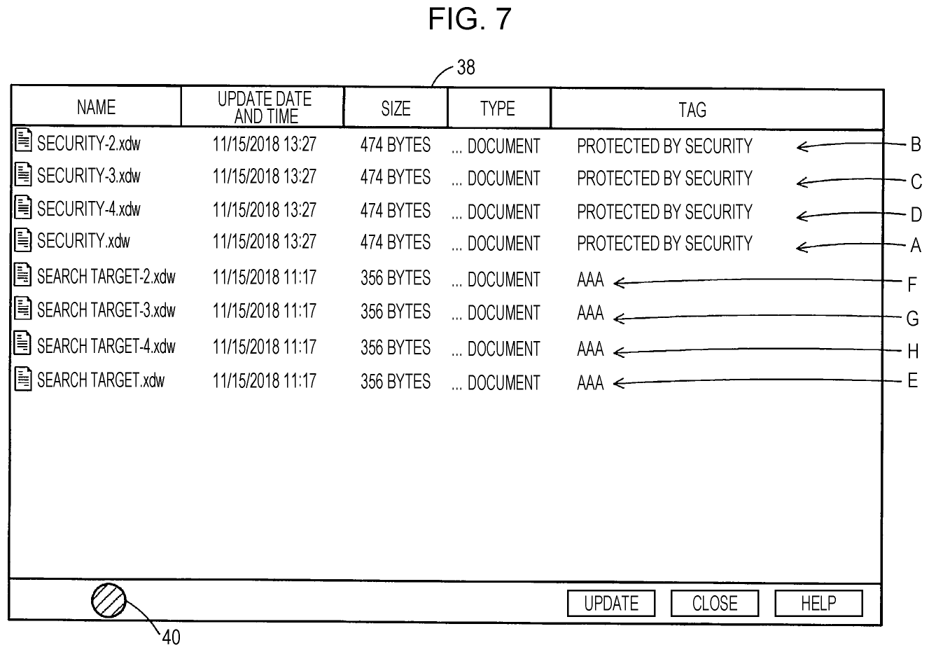

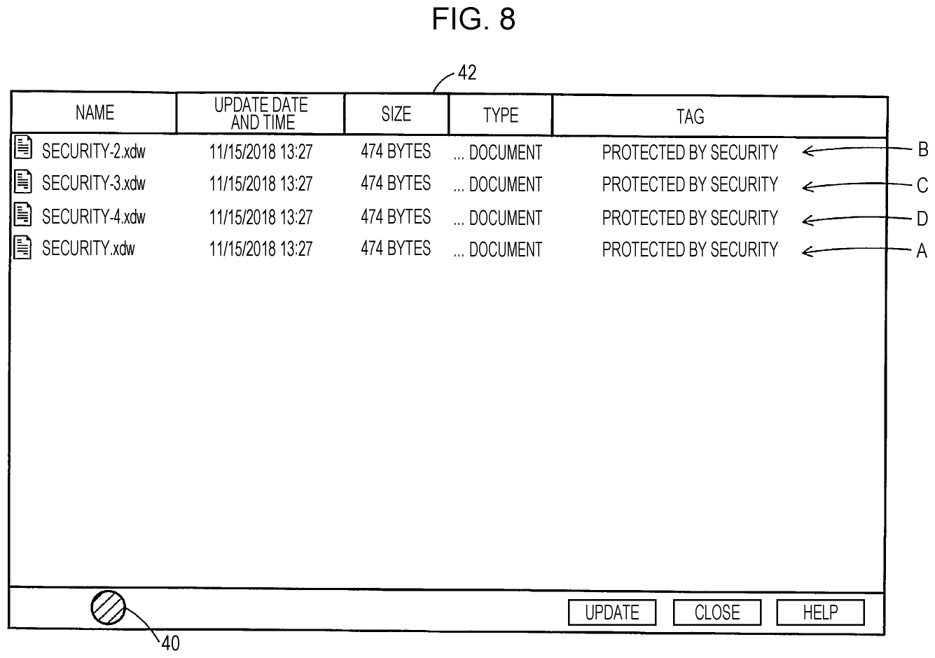

The display controller 26 may execute any of the first mode, the second mode, or the third mode. The display controller 26 executes a mode selected by the user, for example. This processing will be described in detail with reference to FIGS. 7 and 8 hereinafter.

FIG. 7 depicts a screen 38. The screen 38 is displayed when the first mode is executed. Similar to the screen 30 depicted in FIG. 4, the screen 38 displays data E, F, G, and H that is the result of a search performed by the search part 18, and data A, B, C, and D that has been set to be excluded from the search by the setting part 20. Furthermore, the display controller 26 causes a switching button image 40 to be displayed on the screen 38. The switching button image 40 is an image for switching the mode to any of the first mode, the second mode, or the third mode, and corresponds to an example of a switching image.

The display controller 26 switches the mode when the user operates the switching button image 40 on the screen. For example, each time the user presses the switching button image 40 (for example, each time the switching button image 40 is clicked), the display controller 26 switches the mode in the order of the first mode, the second mode, and the third mode. Thus, the screen that is displayed on the display part of the UI 14 is switched in the order of a screen corresponding to the first mode, a screen corresponding to the second mode, and a screen corresponding to the third mode.

For example, in a case where the user presses the switching button image 40 once on the screen 38 corresponding to the first mode, the display controller 26 switches the mode from the first mode to the second mode. The screen is thereby switched from the screen 38 corresponding to the first mode to a screen corresponding to the second mode. FIG. 8 depicts a screen 42 corresponding to the second mode. Similar to the screen 32 depicted in FIG. 5, the screen 42 does not display the result of a search performed by the search part 18, and displays data A, B, C, and D that has been set to be excluded from the search by the setting part 20. Furthermore, the display controller 26 causes the switching button image 40 to be displayed on the screen 42.

In a case where the user presses the switching button image 40 once on the screen 42 corresponding to the second mode, the display controller 26 switches the mode from the second mode to the third mode. The screen is thereby switched from the screen 42 corresponding to the second mode to a screen corresponding to the third mode. Similar to the screen 34 depicted in FIG. 6, the screen corresponding to the third mode displays data E, F, G, and H that is the result of a search performed by the search part 18, and does not display data A, B, C, and D that has been set to be excluded from the search by the setting part 20. Furthermore, the screen corresponding to the third mode displays the switching button image 40.

In a case where the user presses the switching button image 40 once on the screen corresponding to the third mode, the display controller 26 switches the mode from the third mode to the first mode. The screen is thereby switched from the screen corresponding to the third mode to the screen 38 corresponding to the first mode.

The order of switching between modes may be an order other than the aforementioned or may be set by the user. Furthermore, switching button images corresponding to each of the first mode, the second mode, and the third mode may be displayed on the screen. For example, a switching button image for instructing execution of the first mode, a switching button image for instructing execution of the second mode, and a switching button image for instructing execution of the third mode may be displayed together with the switching button image 40 or instead of the switching button image 40. Furthermore, information indicating the quantity of data that has been set to be excluded from a search may be displayed on the screen corresponding to each mode.

The display controller 26 may execute any of the first mode, the second mode, or the third mode in accordance with the result of a search performed by the search part 18 or the data that has been set to be excluded from a search by the setting part 20. In this case also, the mode may be switched according to a switching instruction from the user.

For example, the display controller 26 may execute the first mode or the third mode if the quantity of data retrieved by the search part 18 is greater than or equal to a first threshold value, and may execute the second mode if the quantity of data retrieved by the search part 18 is less than the first threshold value. Furthermore, the display controller 26 may switch the mode in stages in accordance with the quantity of data retrieved by the search part 18. For example, the display controller 26 may execute the second mode if the quantity of data retrieved by the search part 18 is less than the first threshold value, may execute the first mode if the quantity of data retrieved by the search part 18 is greater than or equal to the first threshold value and less than a second threshold value that is greater than the first threshold value, and may execute the third mode if the quantity of data retrieved by the search part 18 is greater than or equal to the second threshold value.

For example, the display controller 26 may execute the first mode or the second mode if the quantity of data that has been set to be excluded from a search by the setting part 20 is greater than or equal to a fourth threshold value, and may execute the third mode if the quantity of data that has been set to be excluded from a search by the setting part 20 is less than the fourth threshold value. Furthermore, the display controller 26 may switch the mode in stages in accordance with the quantity of data that has been set to be excluded from a search by the setting part 20. For example, the display controller 26 may execute the third mode if the quantity of data that has been set to be excluded from a search by the setting part 20 is less than the fourth threshold value, may execute the first mode if the quantity of data that has been set to be excluded from a search by the setting part 20 is greater than or equal to the fourth threshold value and less than a fifth threshold value that is greater than the fourth threshold value, and may execute the second mode if the quantity of data that has been set to be excluded from a search by the setting part 20 is greater than or equal to the fifth threshold value.

The mode switching conditions and threshold values are merely examples and may be set by the user.

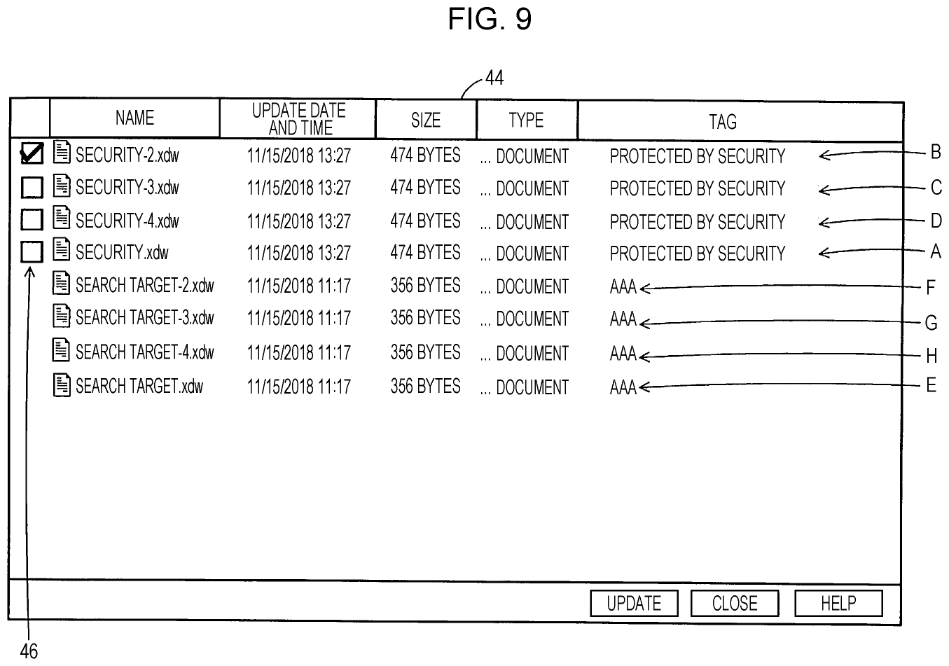

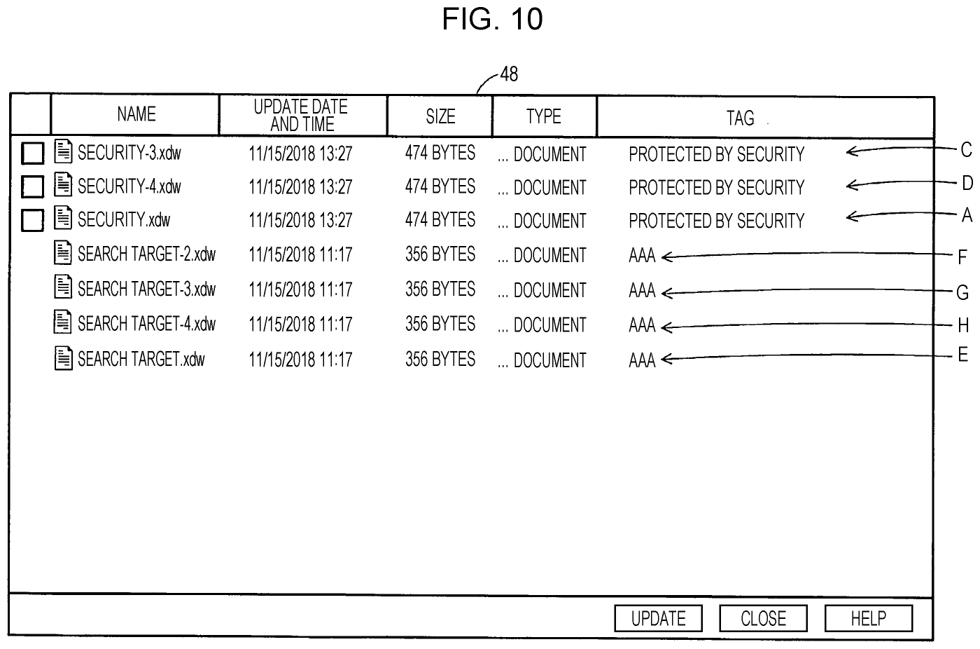

The data that has been set to be excluded from a search by the setting part 20 and displayed on the display part of the UI 14 may be set as data that is not to be displayed. In this case, the display controller 26, after the setting to not be displayed has been implemented, does not cause the display part to display the data that has been set as data that is not to be displayed, when causing the display part to display the result of a search performed by the search part 18. This processing will be described with reference to FIGS. 9 and 10 hereinafter.

FIG. 9 depicts a screen 44. The screen 44 is displayed when the first mode is executed. Similar to the screen 30 depicted in FIG. 4, the screen 44 displays data E, F, G, and H that is the result of a search performed by the search part 18, and data A, B, C, and D that has been set to be excluded from the search by the setting part 20. Checkboxes 46 are displayed corresponding to each item of data A, B, C, and D that has been set to be excluded from the search. The checkboxes 46 are images for setting the data associated with the checkbox 46 in question as data that is not to be displayed. If a check mark is displayed in a checkbox 46, the data associated with the checkbox 46 is set as data that is not to be displayed. The user is able to cause check marks to be displayed or not displayed in the checkboxes 46 by operating the UI 14. For example, a check mark is displayed in the checkbox 46 corresponding to data B, and data B is set as data that is not to be displayed.

In a case where a search is performed by the search part 18 with data B being set as data that is not to be displayed, the display controller 26 causes the display part of the UI 14 to display the screen 48 depicted in FIG. 10. The display controller 26 does not cause the screen 48 to display the data B that has been set as data that is not to be displayed, and causes the screen 48 to display data E, F, G, and H that is the result of a search performed by the search part 18 and data A, C, and D that has been set to be excluded from the search by the setting part 20 and has not been set as data that is not to be displayed.

It should be noted that a setting screen for switching between non-display and display may be displayed, and data that has been set to not be displayed (for example, data B) may be set as data to be displayed by the user on the setting screen.

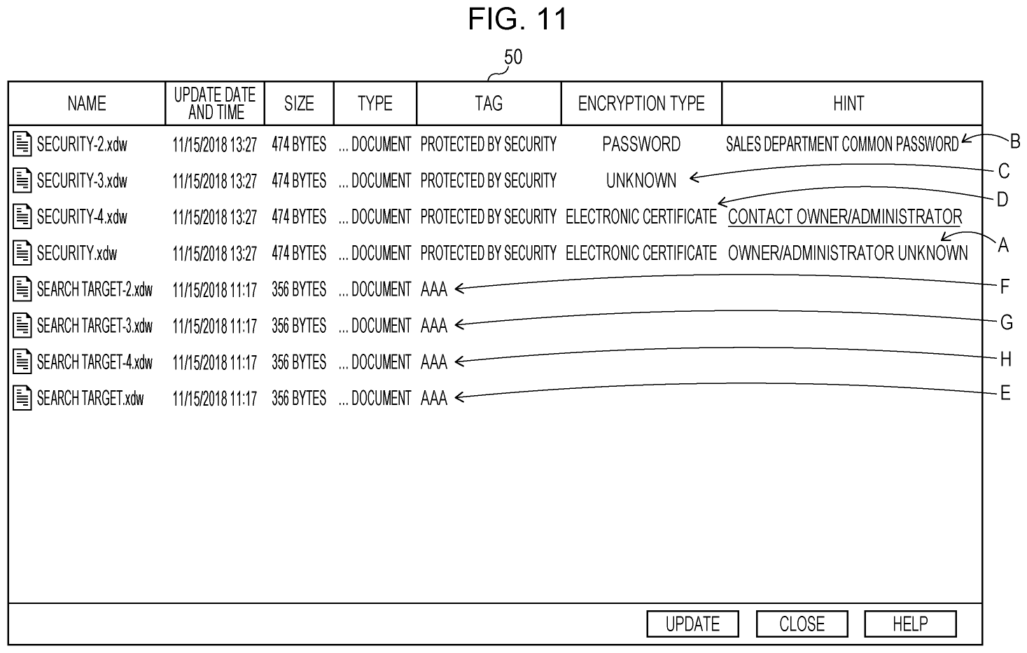

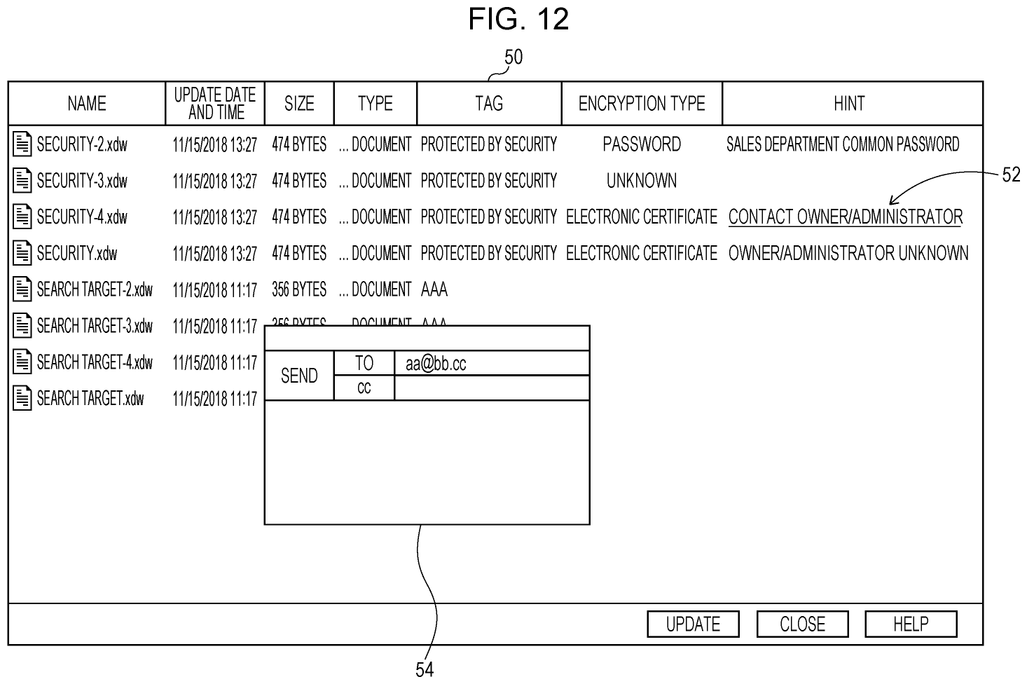

The display controller 26 may cause the display part of the UI 14 to display information for accessing inaccessible information. For example, the display controller 26 causes the display part to display information for decrypting encrypted data. This processing will be described with reference to FIGS. 11 and 12 hereinafter.

FIG. 11 depicts an example of a screen that displays a search result. The screen 50 displays data E, F, G, and H that is the result of a search performed by the search part 18, and data A, B, C, and D that has been set to be excluded from the search by the setting part 20. Furthermore, information indicating the type of encryption and hint information are displayed as well as information indicating the name of the data, information indicating an update date/time of the data, information indicating the size of the data, information indicating the type of data, and tag information. The information indicating the type of encryption and the hint information are examples of information for accessing inaccessible information and are included in the metadata.

The type of encryption is the type of technology used for the encryption, for example. For instance, a password, an electronic certificate, or the like for encryption corresponds to an example of the type of encryption. In other words, information indicating the type of encryption indicates information that is necessary for decryption. For example, data A and D is encrypted using an electronic certificate, and the electronic certificate is necessary to decrypt the encrypted data A and D. Furthermore, data B is encrypted using a password, and the password is necessary to decrypt the encrypted data B.

Hint information is information that serves as a hint for decrypting encrypted data or information that indicates a comment. For example, the hint information associated with data B indicates that the password for decrypting data B is the sales department common password. Furthermore, the hint information associated with data D is information indicating contact details for the owner or administrator of the electronic certificate for decrypting data D. For example, information indicating the email address, telephone number, or the like of the owner or administrator is associated with data D as hint information. It should be noted that the display controller 26 may acquire information such as the email address or telephone number of the owner or administrator from information indicating the owner or administrator of a folder or information managed in an external apparatus, and cause the information to be displayed as hint information on the screen 50 in association with data D.

In a case where the user designates the hint information associated with data D on the screen 50 using the UI 14 (for example, in a case where the hint information is clicked), the controller 24 executes processing for contacting the owner or administrator of the electronic certificate on the basis of the hint information.

For example, information indicating the email address of the owner or administrator is associated with data D as hint information. In a case where the user clicks the hint information associated with data D on the screen 50 using the UI 14, the controller 24 activates email software, as indicated by reference number 52 depicted in FIG. 12. A window 54 for creating and transmitting email is thereby displayed on the screen 50. The window 54 is a display region that is allocated to the email software on the screen 50. The controller 24 additionally sets the email address associated with data D, as the destination for the email. An email address “aa@bb.cc” is automatically entered in the destination field in the window 54. That is, the email software is activated with the email address of the owner or administrator being entered in the destination field. The user is able to consult with the owner or administrator using email. It goes without saying that a telephone number or the like of the owner or administrator may be displayed together with an email address or instead of an email address. In this way, a contact method for obtaining information for decrypting encrypted data is provided to the user.

The functions of each part of the aforementioned information processing apparatus 10 are realized by means of a collaboration between hardware and software, as an example. Specifically, the information processing apparatus 10 is provided with one or more processors such as CPUs that are not depicted. The functions of each part of the information processing apparatus 10 are realized by the one or more processors reading and executing programs stored in a storage apparatus that is not depicted. The programs are stored in the storage apparatus by way of a recording medium such as a CD or DVD or by way of a communication path such as a network. As another example, the functions of each part of the information processing apparatus 10 may be realized by means of a hardware resource such as a processor, an electronic circuit, or an ASIC (application-specific integrated circuit), for example. A device such as a memory may be used for that implementation. As yet another example, the functions of each part of the information processing apparatus 10 may be realized by means of a DSP (digital signal processor), an FPGA (field programmable gate array), or the like.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a search part that searches for data that includes information used for searching:
a setting part that, in a case where it is not possible to access the information, sets the data that includes the information that cannot be accessed, to be excluded from a search performed by the search part; and
a display controller that causes a display part to display a result of the search performed by the search part, and causes the display part to display the data that has been set to be excluded from the search by the setting part.

2. The information processing apparatus according to claim 1,
wherein the data that includes the information that cannot be accessed is encrypted data.

3. The information processing apparatus according to claim 2,
wherein the data that includes the information that cannot be accessed is data that is not permitted to be decrypted by a user who instructed the search.

4. The information processing apparatus according to claim 1,
wherein the display controller executes any of:
a first mode in which the result of the search and the data that has been set to be excluded from the search by the setting part are displayed on the same screen;
a second mode in which the result of the search is not displayed by the display part, and the data that has been set to be excluded from the search by the setting part is displayed by the display part; or
a third mode in which the data that has been set to be excluded from the search by the setting part is not displayed by the display part, and the result of the search is displayed by the display part.

5. The information processing apparatus according to claim 2,
wherein the display controller executes any of:
a first mode in which the result of the search and the data that has been set to be excluded from the search by the setting part are displayed on the same screen;
a second mode in which the result of the search is not displayed by the display part, and the data that has been set to be excluded from the search by the setting part is displayed by the display part; or
a third mode in which the data that has been set to be excluded from the search by the setting part is not displayed by the display part, and the result of the search is displayed by the display part.

6. The information processing apparatus according to claim 3,
wherein the display controller executes any of:
a first mode in which the result of the search and the data that has been set to be excluded from the search by the setting part are displayed on the same screen;
a second mode in which the result of the search is not displayed by the display part, and the data that has been set to be excluded from the search by the setting part is displayed by the display part; or
a third mode in which the data that has been set to be excluded from the search by the setting part is not displayed by the display part, and the result of the search is displayed by the display part.

7. The information processing apparatus according to claim 4,
wherein the display controller, in addition, causes the display part to display a switching image for switching a mode to any of the first mode, the second mode, or the third mode, and switches the mode in a case where the switching image is operated by a user.

8. The information processing apparatus according to claim 5,
wherein the display controller, in addition, causes the display part to display a switching image for switching a mode to any of the first mode, the second mode, or the third mode, and switches the mode in a case where the switching image is operated by a user.

9. The information processing apparatus according to claim 6,
wherein the display controller, in addition, causes the display part to display a switching image for switching a mode to any of the first mode, the second mode, or the third mode, and switches the mode in a case where the switching image is operated by the user.

10. The information processing apparatus according to claim 1,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

11. The information processing apparatus according to claim 2,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

12. The information processing apparatus according to claim 3,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

13. The information processing apparatus according to claim 4,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

14. The information processing apparatus according to claim 5,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

15. The information processing apparatus according to claim 6,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

16. The information processing apparatus according to claim 7,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

17. The information processing apparatus according to claim 8,
wherein, in a case where the data that has been set to be excluded from the search by the setting part and has been displayed on the display part is set as data that is not to be displayed, the display controller, after the setting to not be displayed has been implemented, does not cause the display part to display the data that has been set to not be displayed, when causing the display part to display the result of a search performed by the search part.

18. The information processing apparatus according to claim 1,
wherein the display controller, in addition, causes the display part to display information for accessing the information that cannot be accessed.

19. An information processing apparatus comprising:
a search part that searches for data that includes information used for searching:
a setting part that, in a case where it is not possible to access the information, sets the data that includes the information that cannot be accessed, to be excluded from a search performed by the search part; and
a display controller that causes a display part to display a result of the search performed by the search part, and causes the display part to display information indicating a quantity of the data that has been set to be excluded from the search by the setting part.

20. A non-transitory computer readable medium storing a program causing a computer to function as:
a search part that searches for data that includes information used for searching:
a setting part that, in a case where it is not possible to access the information, sets the data that includes the information that cannot be accessed, to be excluded from a search performed by the search part; and
a display controller that causes a display part to display a result of the search performed by the search part, and causes the display part to display the data that has been set to be excluded from the search by the setting part.
